(19) United States
(12) Patent Application Publication
(10) Pub. No.: US 2024/0399660 A1
(43) Pub. Date: Dec. 5, 2024

(54) THREE-DIMENSIONAL PRINTER APPARATUS WITH PASSIVE LUBRICANT REPLENISHMENT

(71) Applicants: NISSAN NORTH AMERICA, INC., Franklin, TN (US); NORTHWESTERN UNIVERSITY, Evanston, IL (US)

(72) Inventors: Nanzhu ZHAO, Novi, MI (US); Evan JONES, Evanston, IL (US); Sandeep PATIL, Farmington Hills, MI (US); Cheng SUN, Wilmette, IL (US)

(21) Appl. No.: 18/326,966

(22) Filed: May 31, 2023

(51) Int. Cl. B29C 64/245; B29C 64/124; B29C 64/30; B33Y 30/00

(52) U.S. Cl. CPC B29C 64/245; B29C 64/124; B29C 64/30; B33Y 30/00

(57) ABSTRACT

A three-dimensional printing system is provided that includes a tank, a textured substrate connected to the tank, and an auxiliary reservoir. The tank contains a liquid photopolymer resin. The textured substrate is configured to allow light to pass through into the liquid photopolymer resin. The auxiliary reservoir contains lubricant, and the textured substrate includes a plurality of internal channels connected to the auxiliary reservoir.

### BACKGROUND

### Field of the Invention

The present invention generally relates to a three-dimensional printing system with passive lubricant replenishment, and a textured window for such a three-dimensional printing system. The three-dimensional printing system includes a tank, a textured substrate connected to the tank, and an auxiliary reservoir. The tank contains a liquid photopolymer resin. The textured substrate is configured to allow light to pass through into the liquid photopolymer resin. The auxiliary reservoir contains lubricant, and the textured substrate includes a plurality of internal channels connected to the auxiliary reservoir. The textured window includes a first substrate that is optically transparent, and a second substrate formed on a surface of the first substrate. The second substrate has a textured surface and a plurality of internal channels formed in the second substrate.

### Background Information

Three-dimensional (“3D”) printers have been used to print a wide variety of three-dimensional products. Objects are printed layer by layer by the 3D printer by curing portions of a light curable photopolymer resin layer by layer, one layer at a time, within a printing area of a tank filled with the photopolymer resin. A curing device, such as an ultraviolet light source, is projected through a transparent substrate or bottom wall of the tank curing each layer of the object on a carrier surface that is at least partially submerged within the photopolymer. The carrier surface is incrementally raised upward as each layer is cured thereon. One problem with such conventional arrangement is that portions of the photopolymer resin can adhere to the transparent substrate (bottom wall of the tank). This adhesion slows and/or delays the printing process, thereby decreasing productivity. It is therefore advantageous to prevent adhesion of the photopolymer to the transparent substrate.

In order to address this problem of adhesion, textured windows have been developed that include a textured surface in contact with the photopolymer resin. The textured surface includes grooves that are configured to hold lubricant. The textured windows are substantially transparent and can be used as the transparent substrate. By providing a layer of the lubricant between the photopolymer resin and the transparent substrate, adhesion between the photopolymer and transparent substrate can be reduced.

Although these lubricant-infused textured windows can improve the printing speed by increasing the slip length along the textured window in the print area, the amount of lubricant along the surface of the textured window is depleted over time. Therefore, adhesion between the photopolymer and the transparent substrate can still become a problem when the amount of lubricant lost reaches a certain level. For example, a 20% loss in lubricant can render the textured window useless for printing due to adhesion problems. In addition, adhesion of the photopolymer to the transparent substrate can damage the textured window.

Therefore, further improvement is needed to reduce the adhesion of the photopolymer to the transparent substrate. In particular, it is desirable to compensate for the loss of lubricant on the surface of the textured window over time and to thereby extend the time which the 3D printer can continuously print.

### SUMMARY

It has been discovered that the lubricant lost over time can be compensated for by providing a stacked replenishment system in which lubricant is passively replenished through layers in the textured window. The system includes a textured window having internal channels and an auxiliary reservoir that contains lubricant and is connected to the internal channels. By providing the auxiliary reservoir of lubricant and the internal channels in the textured window, lubricant lost over time can be replenished through the internal channels of the textured window to the surface facing the photopolymer resin while maintaining a simple system design. In particular, by replenishing the lubricant through the internal channels in the textured window, an even replenishment across the printing area can be ensured while maintaining the mechanical stability necessary for a flat printing surface. Lubricant can also be replenished through the textured window by providing at least one porous layer in the textured window between the printing surface and the internal channels.

Therefore, it is desirable to provide a three-dimensional printing system that includes such a stacked replenishment system with an auxiliary reservoir and internal channels in the textured window. It is also desirable to provide a textured window that includes a textured surface configured to hold lubricant and internal channels for allowing the lubricant to flow through the textured window to the textured surface.

In view of the state of the known technology, one aspect of the present disclosure is to provide a three-dimensional printing system. The three-dimensional printing system includes a tank containing a liquid photopolymer resin, a textured substrate connected to the tank, and an auxiliary reservoir containing lubricant. The textured substrate is configured to allow light to pass through into the liquid photopolymer resin. The textured substrate also includes a plurality of internal channels connected to the auxiliary reservoir. By providing the auxiliary reservoir and the plurality of channels in the textured substrate, lubricant lost during operation of the three-dimensional printing system can be passively replenished while maintaining a simple system design, thereby preventing adhesion of the liquid photopolymer resin to the textured substrate and allowing for longer and higher-speed continuous printing as compared with conventional three-dimensional printers.

Another aspect of the present disclosure is to provide a textured window for a three-dimensional printing system. The textured window includes a first substrate that is optically transparent and a second substrate formed on a surface of the first substrate. The second substrate has a textured surface and a plurality of internal channels formed in the second substrate.

### BRIEF DESCRIPTION OF THE DRAWINGS

Referring now to the attached drawings which form a part of this original disclosure:

FIG. 1 is a perspective view of a 3D printer apparatus including a printer assembly having a textured window according to a first embodiment;

FIG. 2(a) is a side view of the printer assembly having the textured window according to the first embodiment;

FIG. 2(b) is a partial enlarged cross sectional view of the printer assembly having the textured window of FIG. 2(a);

FIG. 3 is a partial enlarged top perspective view of the textured window of FIG. 2(a);

FIG. 4 is a partial enlarged side view of the printer assembly having the textured window of FIG. 2(a);

FIG. 5(a) is a top view of a textured window according to a second embodiment;

FIG. 5(b) is a top perspective view of a portion of the textured window according to the second embodiment;

FIG. 5(c) is a top exploded perspective view of the textured window according to the second embodiment;

FIG. 5(d) is a top perspective view of the textured window according to the second embodiment;

FIG. 6(a) is a top perspective view of a portion of a textured window according to a third embodiment; and

FIG. 6(b) is a top perspective view of the textured window according to the third embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

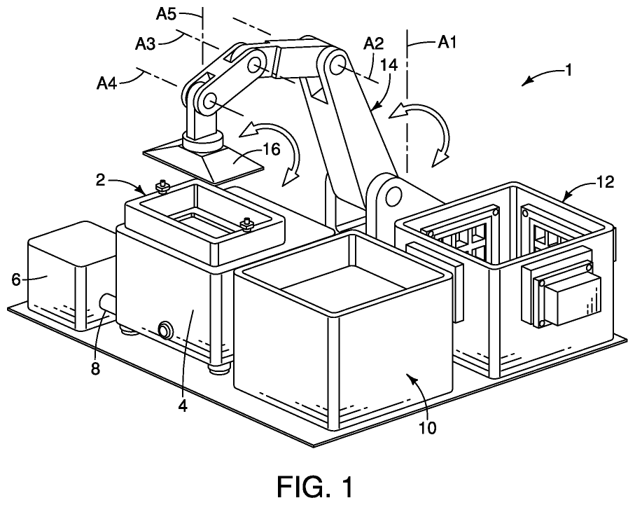

Referring initially to FIG. 1, a three-dimensional printer apparatus 1 (hereinafter the 3D printer apparatus 1) is illustrated in accordance with a first embodiment. The 3D printer apparatus 1 includes a printer assembly 2 having a tank 4. The printer apparatus 1 also includes a reservoir 6, a pipe 8, a rinse station 10, a final curing station 12, a robotic arm 14 and an object carrier 16 connected to the robotic arm 14.

As shown in FIG. 1, the printer assembly 2, the reservoir 6, the pipe 8, the rinse station 10, the final curing station 12, the robotic arm 14 and the object carrier 16 are shown as an assembled group of devices. Alternatively, the 3D printer apparatus 1 can be separate stations that are individual units where the robotic arm 14, or a series of robotic arms are operated together in order to access and utilize the features of each of separated versions of the printer assembly 2, the rinse station 10 and the final curing station 12. It should be understood that the 3D printer apparatus 1 can include any suitable devices in addition to the printer assembly 1. For example, the 3D printer apparatus 1 can include only the printer assembly 2 and the robotic arm 14.

The printer assembly 2, the reservoir 6, the pipe 8, the rinse station 10, the final curing station 12, the robotic arm 14 and the object carrier 16 can each be formed of any suitable material, such as a plastic material, a polymer materials and/or a metallic material.

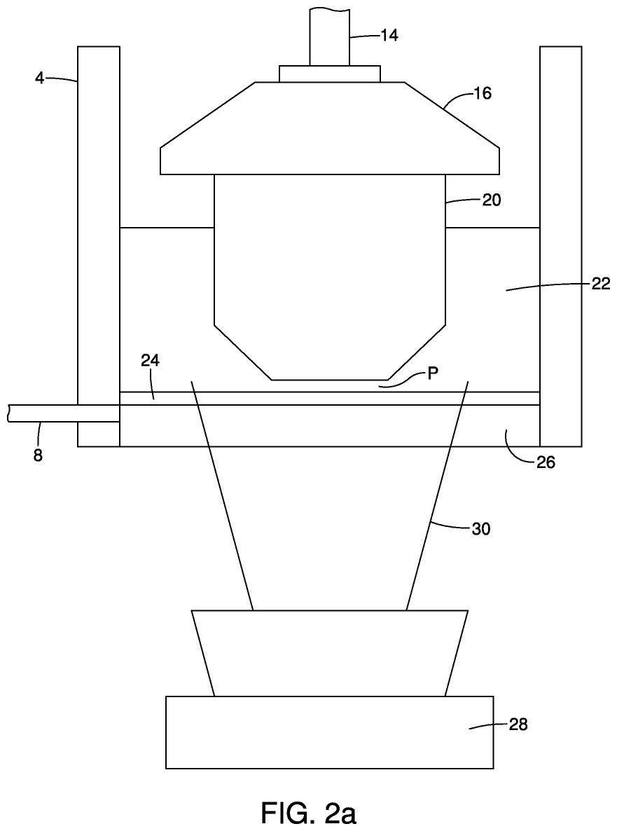

As shown schematically in FIG. 2, the printer assembly 2 includes a tank 4 that has a textured window 26 and the object carrier 16 connected to the robotic arm 18. The object carrier 16 is configured to carry an object 20 that is printed by the printer assembly 2. The printer assembly 2 also includes a resin curing device 28 that emits ultraviolet light 30. A more detailed description of each of these portions of the printer assembly 2 is provided after a brief overview of the basic functions of these features.

As is also shown in FIG. 2, during operation of the printer assembly 2, the tank 4 is at least partially filled with two differing liquid layers—top liquid layer 22 and bottom liquid layer 24. The top liquid layer 22 is a polymerizable resin that covers the bottom liquid layer 24. The top liquid layer 22 can be any suitable polymerizable resin, for example a photopolymer resin that is polymerized by the ultraviolet light 30. The top liquid layer 22 is preferably a photopolymer resin. In particular, the top liquid layer 22 can be formed of: a nylon having a photoinitiator wavelength of 290-315 nm, an acrylic having a photoinitiator wavelength of 290-315 nm, a styrene acrylonitrile having a photoinitiator wavelength of 290-330 nm, a polycarbonate having a photoinitiator wavelength of 280-310 nm, a polystyrene having a photoinitiator wavelength of 310-325 nm, a polyethylene having a photoinitiator wavelength of 300-340 nm, a polypropylene having a photoinitiator wavelength of 290-370 nm, an acrylonitrile butadiene styrene (“ABS”) photopolymer having a photoinitiator wavelength of 300-385 nm, a polyvinyl chloride (“PVC”) homopolymer having a photoinitiator wavelength of approximately 320 nm, a PVC copolymer having a photoinitiator wavelength of 330-370 nm, a polyurethane (aromatic) having a photoinitiator wavelength of 350-415 nm, or a mixture thereof.

The top layer 22 flows freely into the printing area P during the operation of the printing assembly 2, as is described in greater detail below. The polymerizable resin that forms the top layer 22 can be supplied to the tank 4 such that the polymerizable resin fills most or all of the interior volume of the tank 4, depending upon the object 20 being printed and the anticipated volume of use of polymerizable resin needed to print the object 20 being printed by the printer assembly 2.

The bottom liquid layer 24 is a lubricant that covers the textured window 26 and forms a liquid layer between the textured window 26 and the top liquid layer 22. One of the purposes of the bottom liquid layer 24 is to separate and space apart the polymerizable resin in the top liquid layer 22 from the textured window 26 of the tank 4. The bottom liquid layer 24 can be formed of any suitable lubricant, such as an oil having a low viscosity and low adhesion. For example, the bottom liquid layer 24 can be formed of a fluorinated oil. The fluorinated oil is preferably a perfluoropolyether (“PFPE”) copolymer, a fluorosilicone polymer, a perfluorocarbon liquid, allicin oil, garlic oil, a synthetic PFPE-based oil that contains polytetrafluoroethylene (“PTFE”) powder such as Krytox® GPL oil, Fomblin® Y PFPE oil, or a mixture thereof. The bottom layer 24 has a thickness of approximately 3 nm to 5 mm from the uppermost top surface of the textured window 26 facing the top liquid layer 22 to the bottom surface of the top liquid layer 22 facing the textured window 26.

The textured window 26 is a structure formed at the bottom of the tank 4 as shown in FIG. 2(a). The textured window 26 can be connected to the bottom of the tank 4 in any suitable manner or can be formed integrally with the bottom of the tank 4. For example, the textured window 26 can be attached to bottom ends or bottom edges of each side wall of the tank 4 to form a liquid tight space within the tank 4. The tank 4 can be manufactured of any suitable material, such as a plastic, a polymer, a metallic material, or mixtures thereof. The textured window 26 is also connected to the pipe 8 such that the liquid from reservoir 6 can be supplied to the textured window 26. The textured window 26 has a total thickness of approximately 10 μm to 5 cm. The textured window 26 is optically transparent and has an ultraviolet light transmittance of at least 60%, preferably at least 90%, such that focused beams of light from the resin curing device 28 pass therethrough and at predetermined areas or portions of the polymerizable resin located within the printing area P.

The resin curing device 28 is installed or located below the tank 4 and is positioned to selectively project light upward through transparent textured window 26 of the tank 4. An electronic controller (not shown) controls operation of the resin curing device 28 to cure and harden the polymerizable resin in the top liquid layer 22 located within the printing area P in order to form the object 20. The resin curing device 28 can be any of a variety of resin curing light sources such as an ultra-violet projector, laser (stereolithography) digital light projector, liquid crystal display, projector or other light emitting device capable of electronic focusing and imaging focused light in order to selectively cure polymerizable resin to form the object 20.

The printing area P is defined as being the space below the object carrier 16 (at and/or below a lower surface of the object 20 being printed) and the upper surface of the bottom liquid layer 24. Further, the printing area P is preferably located above and spaced apart from the textured window 26 of the tank 4 but can be in contact with the textured window 26 if the bottom liquid layer 24 is depleted during operation.

As shown in FIG. 2(b), the textured window 26 includes a first substrate 32 and a second substrate 34 provided on the top surface of the first substrate 32. The first substrate 32 is formed of any suitable optically transparent material. For example, the first substrate 32 can be made of any suitable transparent material, such as plexiglass, traditional glass, any suitable transparent plastic or polymer material, or a mixture thereof. Preferably, the first substrate 32 is made of a glass material. The first substrate 32 has a thickness of approximately 9 μm to 3 cm.

The second substrate 34 can be formed on the top surface of the first substrate 32 in any suitable manner. For example, the second substrate 34 can be adhered to the first substrate 32 by an adhesive material. Alternatively, the second substrate 34 can be deposited on the first substrate 32 by any suitable deposition method, such as chemical vapor deposition (“CVD”), etching or additive and subtractive methods. The second substrate 34 is formed of any suitable optically transparent and soft polymer material. For example, the second substrate 34 can be made of an optically transparent silicone polymer such as polydimethylsiloxane (“PDMS”), an optically transparent fluorinated polymer, or a mixture thereof. Preferably, the second substrate 34 is made of PDMS. The second substrate 34 can also be porous. The second substrate 34 preferably has a porosity of approximately 30% to 70%. The second substrate 34 has a thickness of approximately 5 nm to 200 μm.

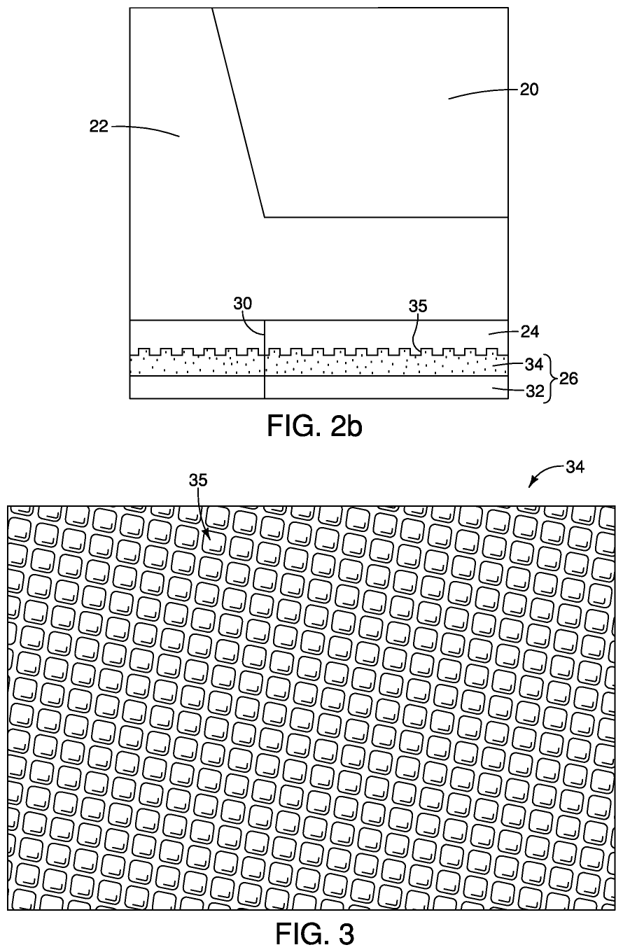

As shown in FIG. 2(b), the second substrate 34 includes a plurality of grooves 35 on the top surface of the second substrate 34 facing the bottom liquid layer 24. The grooves 35 form a textured surface on the top of the second substrate 34 facing the bottom liquid layer 24. The grooves 35 are configured to hold liquid from the bottom liquid layer 24 and can have any suitable shape. For example, the grooves 35 have a pillar-like shape and are formed along the top surface of the second substrate 34. Preferably, the grooves 35 have a cubic shape as illustrated in FIG. 3 with a same length, width and depth from the top surface of the second substrate 34. The grooves 35 have a depth, length and width each ranging from approximately 0.1 μm to 100 μm.

The grooves 35 in FIG. 3 are shown from the bottom surface of the second substrate 34. As shown in FIG. 3, the grooves 35 are formed in a pattern along the top surface of the second substrate 34. For example, as shown in FIG. 3, the grooves 35 in the top surface of the second substrate 34 can be formed as a pattern of cubic pillars projecting toward the bottom surface of the second substrate. However, it should be understood that the grooves 35 can have any suitable shape for holding the lubricant in the bottom liquid layer 24.

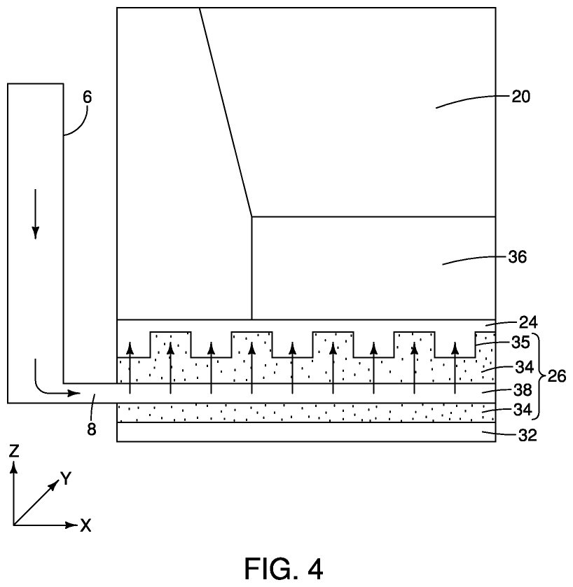

FIG. 4 shows an enlarged view of the textured window 26, the reservoir 6 and the pipe 8 of FIG. 2(a). As shown in FIG. 4, the second substrate 34 includes the plurality of grooves 35 on the top surface of the second substrate 34 facing the object 20. As the resin in the top liquid layer 22 is cured, it forms a cured layer 36 between the object 20 being printed and the bottom liquid layer 24.

The second substrate 34 also includes an internal channel 38 formed between two layers 34 of the second substrate 34. The internal channel 38 is connected to the pipe 8 such that lubricant from the reservoir 6 can flow into the internal channel 38 of the second substrate 34. The internal channel 38 has a height of approximately 0.01 μm to 50 μm in the z direction and a width of approximately 0.01 μm to 50 μm in the y direction. The internal channel 38 can extend any suitable length in the x direction along an internal surface of the second substrate 34. The internal channel 38 preferably extends along an entire length of the second substrate 34.

As discussed previously, the second substrate 34 is formed of any suitable optically transparent and soft polymer material. For example, the second substrate 34 can be made of an optically transparent silicone polymer such as PDMS, an optically transparent fluorinated polymer, or a mixture thereof. The second substrate 34 is preferably made of PDMS. The second substrate 34 is also porous and has a porosity of approximately 30% to 70% and a pore size of approximately 100 μm or less. The second substrate 34 has a thickness of approximately 5 nm to 200 μm.

As shown by the arrows in FIG. 4, during operation of the printer assembly 2, the lubricant from the reservoir 6 flows into the internal channel 38 of the second substrate 34 via the pipe 8. The lubricant then flows from the internal channel 38 through the top layer of the porous second substrate 34 to the bottom liquid layer 24. By supplying the lubricant from the reservoir 6 to the internal channel 38 of the second substrate 34, lubricant lost during operation of the printer assembly 2 can be replenished without interrupting the operation of the printer assembly 2, thereby allowing a longer continuous printing time.

Although not shown, it should be understood by those skilled in the art that the operation of the reservoir 6 can be controlled in any suitable manner. For example, the reservoir 6 can be controlled by an electronic controller such that when a sensor detects that the liquid level of the bottom liquid layer 24 or the liquid level of the reservoir 6 has fallen below a certain level, additional lubricant is supplied to the internal channel 38 from the reservoir 6 through the pipe 8. Alternatively, the reservoir 6 can be controlled by an electronic or manual controller to supply lubricant to the internal channel 38 at predetermined times or time intervals.

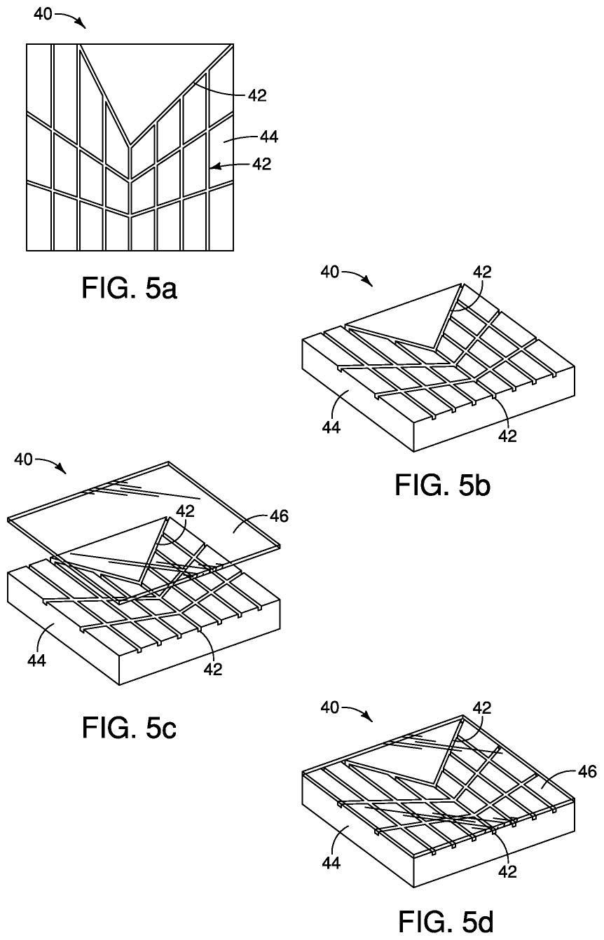

FIGS. 5(a) and 5(b) show a textured window 40 for a 3D printer assembly in accordance with a second embodiment. The textured window 40 includes a first substrate 44 having a plurality of internal channels 42 formed therein. The first substrate 44 is a first layer of the textured window 40. As shown in FIG. 5(a), the internal channels 42 are formed in a leaf-like pattern on the surface of the first substrate 44. The internal channels 42 each have a width of approximately 0.01 μm to 50 μm and extend along an entire length and width of the first substrate 44. As shown in FIG. 5(b), the internal channels 42 are grooves formed in the first substrate 44. The internal channels 42 have a depth of approximately 0.01 μm to 50 μm from the top surface of the first substrate 44.

The first substrate 44 is formed of any suitable optically transparent and soft polymer material. For example, the first substrate 44 can be made of an optically transparent silicone polymer such as PDMS, an optically transparent fluorinated polymer, or a mixture thereof. The first substrate 44 is preferably made of PDMS. The first substrate 44 is also porous and has a porosity of approximately 30% to 70% and a pore size of approximately 100 μm or less. The first substrate 44 has a thickness of approximately 5 nm to 200 μm.

As shown in FIGS. 5(c) and 5(d), the textured window 40 also includes a second substrate 46. The second substrate 46 is a second layer of the textured window 40. The second substrate 46 is formed of any suitable optically transparent and soft polymer material. For example, the second substrate 46 can be made of an optically transparent silicone polymer such as PDMS, an optically transparent fluorinated polymer, or a mixture thereof. The second substrate 46 is preferably made of PDMS. The second substrate 46 is also porous and has a porosity of approximately 30% to 70% and a pore size of approximately 100 μm or less. The second substrate 46 has a thickness of approximately 5 nm to 200 μm. The second substrate 46 is preferably made of the same material as the first substrate 44.

The textured window 40 may also optionally include a third substrate (not shown) formed of an optically transparent material and disposed on the opposite side of the first substrate 42 from the second substrate 46 such that the first substrate 42 is provided between the second substrate 46 and the third substrate. The third substrate can be formed of any suitable optically transparent material, such as plexiglass, traditional glass, any suitable transparent plastic or polymer material, or a mixture thereof.

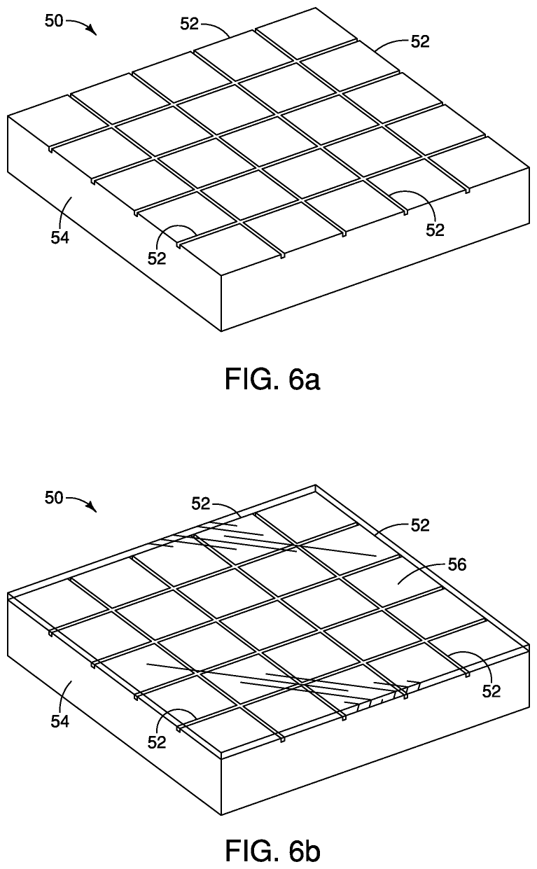

FIGS. 6(a) and 6(b) show a textured window 50 for a 3D printer assembly in accordance with a third embodiment. Like the textured window 40 of the second embodiment, the textured window 50 includes a plurality of internal channels 52 formed in a first substrate 54. The first substrate 54 is a first layer of the textured window 50.

However, as shown in FIGS. 6(a) and 6(b), the internal channels 52 are formed in a grid-like pattern on the surface of the first substrate 54, rather than a leaf-like pattern as in the third embodiment. However it should be understood that the internal channels 52 may be formed in any suitable pattern on the surface of the first substrate 54. The internal channels 52 each have a width of approximately 0.01 μm to 50 μm and extend along an entire length and width of the first substrate 54. The internal channels 52 are grooves formed in the first substrate 54. The internal channels 52 have a depth of approximately 0.01 μm to 50 μm from the top surface of the first substrate 54.

The first substrate 54 is formed of any suitable optically transparent and soft polymer material. For example, the first substrate 54 can be made of an optically transparent silicone polymer such as PDMS, an optically transparent fluorinated polymer, or a mixture thereof. The first substrate 54 is preferably made of PDMS. The first substrate 54 is also porous and has a porosity of approximately 30% to 70% and a pore size of approximately 100 μm or less. The first substrate 54 has a thickness of approximately 5 nm to 200 μm.

As shown in FIG. 6(b), the textured window 50 also includes a second substrate 56 as a second layer of the textured window 50. The second substrate 56 is formed of any suitable optically transparent and soft polymer material, such as an optically transparent silicone polymer, an optically transparent fluorinated polymer, or a mixture thereof. The second substrate 56 is preferably made of PDMS. The second substrate 56 is also porous and has a porosity of approximately 30% to 70% and a pore size of approximately 100 μm or less. The second substrate 56 has a thickness of approximately 5 nm to 200 μm. The second substrate 56 is preferably made of the same material as the first substrate 54.

The textured window 50 may also optionally include a third substrate (not shown) formed of an optically transparent material and disposed on the opposite side of the first substrate 52 from the second substrate 56 such that the first substrate 52 is provided between the second substrate 56 and the third substrate. The third substrate can be formed of any suitable optically transparent material, such as plexiglass, traditional glass, any suitable transparent plastic or polymer material, or a mixture thereof.

By providing the textured window having a plurality of internal channels and an auxiliary reservoir connected to the textured window, lubricant lost during operation of the printer assembly can be replenished, thereby ensuring an increased slip length on the textured surface of the textured window and a faster printing time by preventing adhesion of the cured material to the textured window. Furthermore, by providing the textured window with porous layers, lubricant can be passively supplied to the textured surface of the textured window from the internal channels through the porous layers of the textured window.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including,” “having” and their derivatives. Also, the terms “part,” “section,” “portion,” or “element” when used in the singular can have the dual meaning of a single part or a plurality of parts.

The terms of degree, such as “approximately” or “substantially” as used herein, mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A three-dimensional printing system comprising:
a tank containing a liquid photopolymer resin;
a textured substrate connected to the tank, the textured substrate being configured to allow light to pass through into the liquid photopolymer resin; and
an auxiliary reservoir containing lubricant,
the textured substrate including a plurality of internal channels connected to the auxiliary reservoir.

2. The three-dimensional printing system according to claim 1, wherein:
the textured substrate comprises a first substrate that is optically transparent and a second substrate formed on a surface of the first substrate,
the second substrate includes a textured surface facing the liquid photopolymer resin, and
the plurality of internal channels is formed in the second substrate.

3. The three-dimensional printing system according to claim 2, wherein
the textured surface includes at least one groove formed in the second substrate.

4. The three-dimensional printing system according to claim 3, wherein
each of the at least one groove has a cubic shape.

5. The three-dimensional printing system according to claim 2, wherein
the first substrate is formed of a glass material.

6. The three-dimensional printing system according to claim 2, wherein
the second substrate is formed of at least one selected from the group consisting of: a silicone polymer and a fluorinated polymer.

7. The three-dimensional printing system according to claim 6, wherein
the second substrate is formed of polydimethylsiloxane.

8. The three-dimensional printing system according to claim 2, wherein
the plurality of internal channels is formed in the second substrate in a branched pattern such that at least some of the plurality of internal channels are connected to each other.

9. The three-dimensional printing system according to claim 1, wherein
the lubricant is a fluorinated oil.

10. The three-dimensional printing system according to claim 1, wherein
the second substrate is formed of a porous polymer material.

11. The three-dimensional printing system according to claim 1, wherein
the second substrate includes a first layer and a second layer each formed of the porous polymer material,
the plurality of internal channels is formed in the first layer, and
the second layer is disposed on a top surface of the first layer such that the second layer is disposed between the first layer and the liquid photopolymer resin.

12. The three-dimensional printing system according to claim 1, wherein
the plurality of internal channels are connected to the auxiliary reservoir by a pipe.

13. The three-dimensional printing system according to claim 1, further comprising
a pump configured to supply the lubricant from the auxiliary reservoir to the plurality of internal channels.

14. A textured window for a three-dimensional printing system, the textured window comprising:
a first substrate that is optically transparent, and
a second substrate formed on a surface of the first substrate,
the second substrate having a textured surface and a plurality of internal channels formed in the second substrate.

15. The textured window according to claim 14, wherein
the textured surface includes at least one groove formed in the second substrate.

16. The textured window according to claim 14, wherein
the first substrate is formed of a glass material.

17. The textured window according to claim 14, wherein
the second substrate is formed of at least one selected from the group consisting of: a silicone polymer and a fluorinated polymer.

18. The textured window according to claim 17, wherein
the second substrate is formed of polydimethylsiloxane.

19. The textured window according to claim 14, wherein
the second substrate is formed of a porous polymer material.

20. The textured window according to claim 14, wherein
the second substrate includes a first layer and a second layer each formed of the porous polymer material, and
the plurality of internal channels is formed in the first layer.
